(19) United States
(12) Patent Application Publication
(10) Pub. No.: US 2011/0216560 A1
(43) Pub. Date: Sep. 8, 2011

(54) TWO STAGE ISOLATED SWITCH-MODE AC/DC CONVERTER

(76) Inventor: Sheng Ye, Oakville (CA)

(21) Appl. No.: 12/717,387

(22) Filed: Mar. 4, 2010

(51) Int. Cl. H02M 3/335

(52) U.S. Cl. 363/21.15

(57) ABSTRACT

An AC/DC two stage converter includes a non-isolated switch-mode regulated AC/DC voltage step-down first stage converter comprising an AC input and a first DC output. The AC voltage applied to the AC input is rectified and switch-mode regulated to a first DC voltage at the first DC output. The first DC voltage is lower than a peak voltage of the AC voltage applied to the AC input. An isolated switch-mode regulated DC/DC second stage converter includes a second DC input coupled to the first DC output and at least one second DC output, wherein the first DC voltage is switch-mode regulated to a second DC voltage at a second DC output.

### TECHNICAL FIELD

This description primarily relates to isolated switch-mode AC/DC power converters, and methods of operating isolated switch-mode AC/DC power converters.

### BACKGROUND

AC/DC power converters convert one rectified DC voltage to another DC voltage.

AC/DC converters can be isolated or non-isolated. Isolated AC/DC converters can be used, for example, as the basis for an AC/DC power supply, such as a “universal” power supply having a wide input AC voltage range.

AC/DC converters can be implemented in switched-mode. Isolated switched-mode AC/DC converters can provide smaller size, lighter weight, and lower heat generation resulting in higher efficiency. Further improvements to isolated switched-mode AC/DC converters would be beneficial.

Isolated switched-mode AC/DC converters can also have greater complexity, sometimes resulting in lower reliability. Again, further improvements to isolated switched-mode AC/DC converters would be beneficial.

### BRIEF DESCRIPTION OF THE DRAWINGS

Example embodiments will now be described with reference to the appended drawings wherein:

FIG. 1 is a block diagram of an example embodiment of a two stage AC/DC converter with example waveforms overlaid.

FIG. 2 is a schematic diagram of a modified buck-boost first stage and flyback second stage example embodiment of the converter of FIG. 1.

FIG. 3 is a conventional buck-boost DC/DC converter.

FIG. 4 is a schematic diagram of a buck first stage and flyback second stage example embodiment of the converter of FIG. 1.

FIG. 5 is a schematic diagram of an example modified buck-boost converter.

FIG. 6 is a schematic diagram of the modified buck-boost converter of FIG. 5 in an “ON” state.

FIG. 7 is a schematic diagram of the modified buck-boost converter of FIG. 5 in an “OFF” state

FIG. 8 is a graphic illustration of current waveforms in components of the modified buck-boost converter of FIG. 5 over time.

FIG. 9 is a graphic illustration of example voltage waveforms in an example embodiment of the converter of FIG. 1.

FIG. 10 is a schematic diagram of an example full bridge second stage.

FIG. 11 is a schematic diagram of an example half bridge second stage.

FIG. 12 is a schematic diagram of an example forward second stage.

FIG. 13 is a schematic diagram of an example push-pull second stage.

FIG. 14 is a schematic diagram of an example LLC half bridge second stage.

FIG. 15 is an example buck first stage and full bridge second stage example embodiment of the converter of FIG. 1.

FIG. 16 is an example buck boost first stage and full bridge second stage example embodiment of the converter of FIG. 1.

### DETAILED DESCRIPTION OF THE DRAWINGS

In this description like reference numerals will be used from implementation to implementation to indicate like components and the description for such components will not be repeated but is understood to apply to such like components, unless expressly stated otherwise or required by the context.

Example implementations of aspects described herein provide an AC/DC two stage converter with a non-isolated switch-mode regulated AC/DC voltage step-down first stage converter comprising an AC input and a first DC output, wherein an AC voltage applied to the AC input is rectified and switch-mode regulated to a first DC voltage at the first DC output, and the first DC voltage is lower than a peak voltage of the AC voltage applied to the AC input, and an isolated switch-mode regulated DC/DC second converter comprising a second DC input coupled to the first DC output and at least one DC output, wherein the first DC voltage is switch-mode regulated to a DC voltage at a DC output.

The first stage converter can include a rectifier and a non-isolated switch-mode regulated DC/DC voltage step-down converter, wherein the rectifier is operatively connected to the AC input and the non-isolated switch-mode regulated DC/DC voltage step-down converter is operatively connected between the rectifier and the first DC output, wherein the rectifier rectifies the AC voltage to a rectified voltage and the non-isolated switch-mode regulated DC/DC voltage step-down converter regulates and steps-down the rectified voltage to the first DC voltage, which first DC voltage is lower than a peak voltage of the rectified voltage.

The non-isolated switch-mode regulated DC/DC voltage step-down converter can be, for example, a buck converter. The non-isolated switch-mode regulated DC/DC voltage step-down converter can be, for example, a buck boost converter.

The second stage DC/DC converter can be, for example, a flyback converter. The second stage DC/DC converter can be, for example, a full bridge converter. The second stage converter can be, for example, a half bridge converter or a half bridge LLC converter. The second stage converter can be a push-pull converter or forward converter. The second stage converter can, for example, include a planar isolation transformer. The second converter can, for example, include a planar isolation transformer and the first DC voltage can be, for example, in a range to properly operate the planar transformer and to allow the second switch to operate at sufficiently high frequency for proper operation of the planar transformer.

The second converter can, for example, include a plurality of DC outputs, wherein the plurality of DC outputs can, for example, include the DC output, and each DC output of the plurality of DC outputs can be, for example, isolated from the other DC outputs. The respective DC voltages can be different from one another. The respective DC voltages can be the same as one another. The respective DC voltages can have a combination of DC voltages that are the same as one another and that are different from one another.

The second stage converter can, for example, include a planar isolation transformer, and the isolation transformer can, for example, have a primary winding associated with the second DC input and a plurality of secondary windings, each secondary winding associated with a respective DC output.

The second stage converter can, for example, include a second MOSFET switch and a second controller is operatively connected to the second MOSFET switch and a second voltage output such that the second controller causes the second MOSFET switch to switch-mode regulate the second stage converter based on a DC output voltage signal.

The first stage converter can, for example, include a first MOSFET switch and a first controller operatively connected to the first MOSFET switch and the first DC output such that the first controller causes the first MOSFET switch to switch-mode regulate the first stage converter based on the first DC output voltage.

The controller in the first and second stage can be combined into one controller.

In another example implementation of an aspect described herein a method of operating an AC/DC two stage converter can, for example, include, in a non-isolated first stage, rectifying an AC voltage at an AC input of the converter to a rectified voltage, and switch-mode regulating the rectified voltage to a first DC voltage lower than a peak AC voltage of the AC input to the converter, wherein the rectified voltage and the first DC voltage share a common voltage ground, and, in an isolated second stage, switch-mode regulating the first DC voltage to a DC voltage at a DC output of the converter, wherein the DC output is isolated from the AC input in the second stage.

Other example implementations of the above aspects and example implementations of further aspects will now be described.

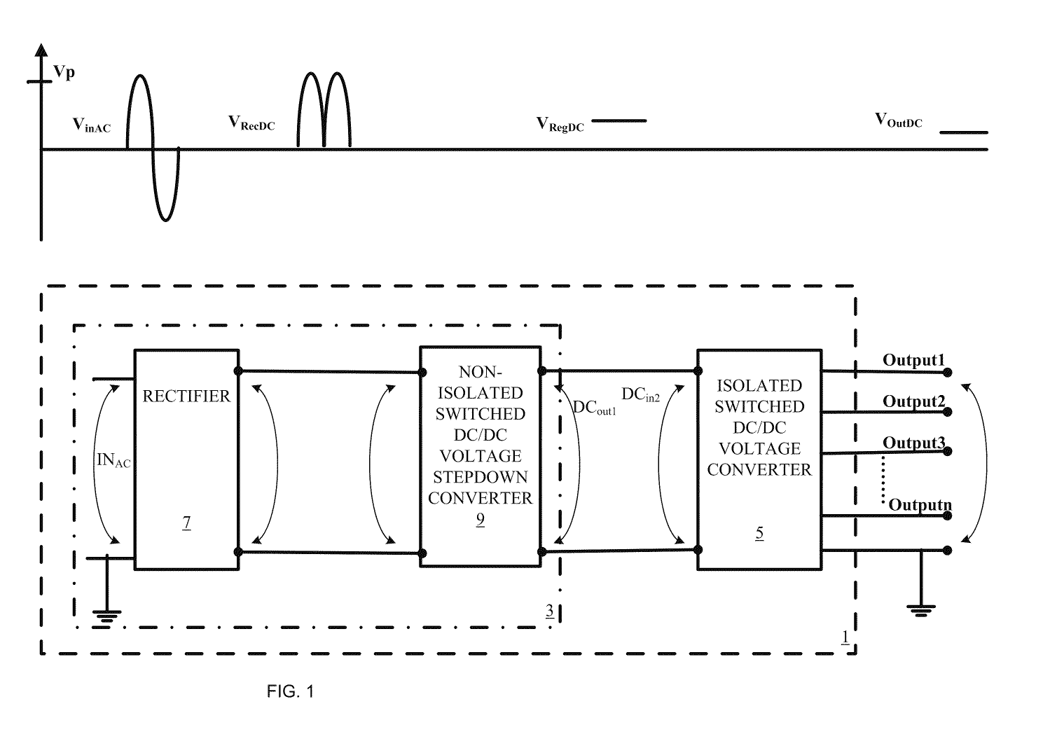

Referring to FIG. 1, an isolated AC/DC two stage converter 1 includes a non-isolated switched AC/DC voltage stepdown first stage converter 3 and an isolated switched DC/DC voltage second stage converter 5.

An intermediate voltage that is lower than the peak voltage Vₚ of the AC input voltage V_{inAC}, such as 10V or 50V or 100V. It is noted for 120V AC voltage, the peak voltage Vₚ will be around 160V and for 220V AC voltage, the peak voltage Vₚ is 310V. The first stage is a non-isolated AC-DC converter 3, which regulate the AC input voltage V_{inAC} at AC input IN_{AC} into a DC output voltage V_{RegDC} at first DC output DCₒᵤₜ₁ which is lower than the peak AC voltage Vₚ. The non-isolated AC-DC converter 3 can include a rectifier 7 followed by a non-isolated DC-DC converter 9. The rectifier 7 rectifies V_{inAC} to V_{RecDC}. The non-isolated AC-DC converter 3 regulates and steps down V_{RecDC} to DCₒᵤₜ₁.

The output Output1 . . . n of the isolated AC-DC converter 1 is regulated by controlling the duty cycle of switches (see example switches shown in detailed example implementation FIGS.) used in the isolated AC-DC converter 1.

Two control methods can be used. One is direct PWM control that does not achieve Power Factor Correction (PFC) at the AC input side. The other is to achieve high Power Factor at the input side using a power factor control method. In PFC control the AC input current is controlled to follow the AC input voltage. Although it is recognized that PFC can be used, the following discussion is made without reference to PFC operation for simplicity. PFC is used in the non-isolated first stage only.

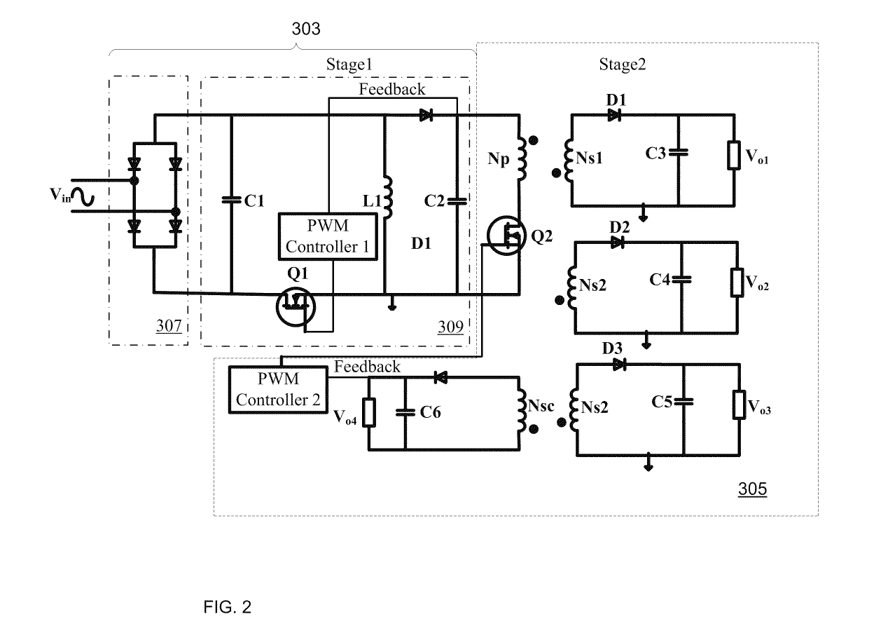

Referring to FIG. 2, an example implementation of the converter 3 is an AC/DC buck-boost converter 303 including a full-bridge rectifier 307 and buck-boost non-isolated DC/DC converter 309 followed by a multiple winding flyback converter 305. The converter 305 is shown with four outputs, but the number of outputs can be changed to any number according to the design requirements. A feedback signal can be selected, for example, from Vo4, and other outputs Vo1, Vo2, Vo3, can be regulated by cross regulation of the transformer windings. Using Vo4 to provide a direct feedback connection is one example of a non-isolated operative connection between the PWM Controller2 of the isolated converter 305. Relying on the cross-regulation of the transformer N and providing a non-isolated operative feedback connection to the PWM controller2 can be very reliable, particularly in planar transformer implementations with tight cross regulation. The operation of the flyback converter 305 is otherwise well-known and will not be discussed further herein.

The capacitance value of C1 can be small or large, or somewhere in between. When C1 is small, the voltage across C1 will fluctuate from almost zero when the input AC voltage crosses the zero point to peak value of the AC voltage. When C1 value is large, the voltage across C1 is almost constant at close to the peak value of AC voltage. When C1 value is somewhere in between, the voltage across C1 will fluctuate. As stage one regulates its output voltage a small capacitor can be used for EMI purposes.

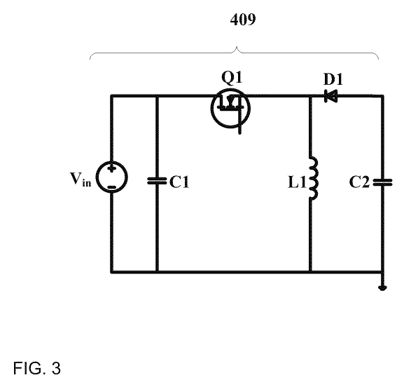

The first stage 303 shown in FIG. 2 includes a revised buck-boost converter 309. The function of first stage is to regulate the AC input to a lower DC voltage (for example 35V) for the input of the second stage. A conventional Buck-Boost 409 is shown in FIG. 3, and a high side driver, not shown, is needed to drive the high side switch (MOSFET Q1). The conventional buck-boost 409 can be employed as the converter 9; however, revised buck-boost 309 having a low side MOSFET driver PWM controller 1 can drive the switch (MOSFET Q1). C1 in the topology shown in FIG. 2 can be small as the control circuit of the first stage 303 can significantly attenuate low frequency AC ripple on C2. The PWM controller 1 is used to control the output voltage of AC-DC converter 303 and PWM controller 2 is used to control the output of the flyback converter 305. Controller 1 and controller 2 can be combined into one controller.

The second stage 5 can be a flyback converter 305 as the input voltage DCᵢₙ₂ for the second stage 5 is stepped down; the voltage stress across Q2 will also be reduced. For example if the DC input for the second stage is 30V, the voltage stress across Q2 will be around 100V, in this case Q2 can operate at a very high switching frequency and still maintain high efficiency. High switching frequency of the second stage 5 means that a small planar transformer N can be used in the design. The planar transformer N can be designed using a multi-layer printed circuit board, all primary and secondary side windings can be tightly coupled and leakage inductance can be controlled. To control all second stage DC outputs, the power supply can regulate one secondary side output and all other outputs will be regulated through cross regulation. A planar transformer can also be well suited to volume production as the resulting parameters of planar transformers can be very consistent from one planar transformer to the next. Possible advantages of this new topology may include:

Input capacitor C1 can be reduced.

Second stage can operate at a very high switching frequency and the size of the transformer can be significantly reduced.

Planar transformer can be used, tight cross regulation of all secondary side can be achieved as the parameters of the transformer affecting cross regulation can be controlled. The parameters of planar transformers tend to be consistent, which can be beneficial for volume production.

Tight cross regulation can be used to control multi-outputs. Feedback loop design can be simplified. Feedback loop design can be reliable.

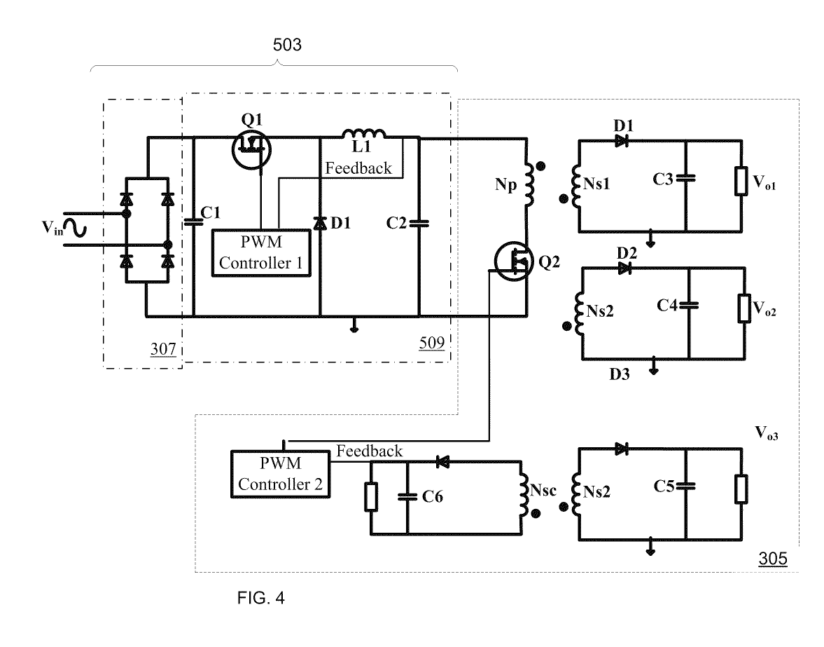

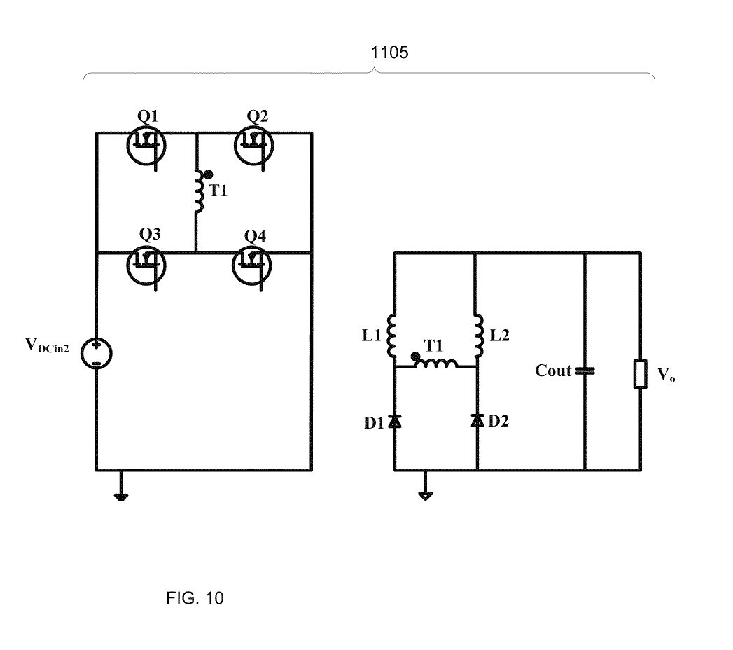

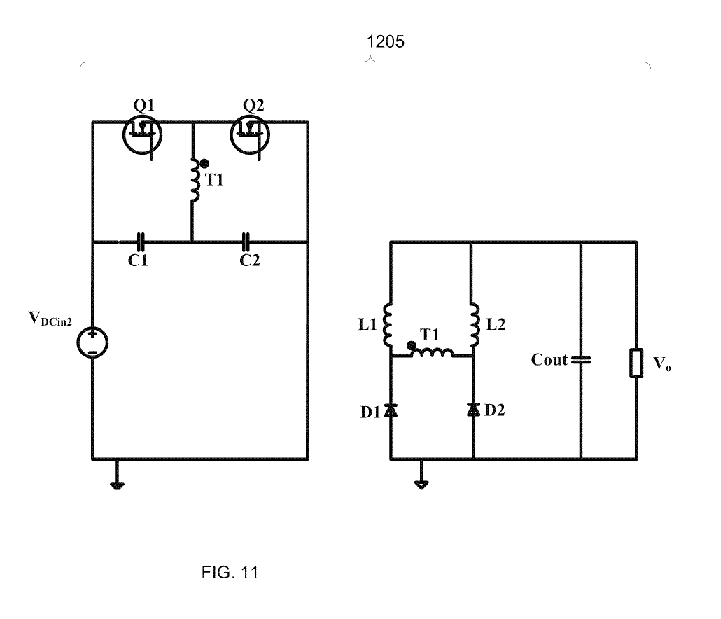

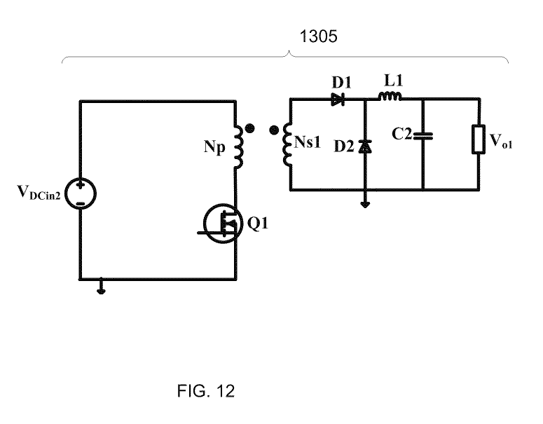

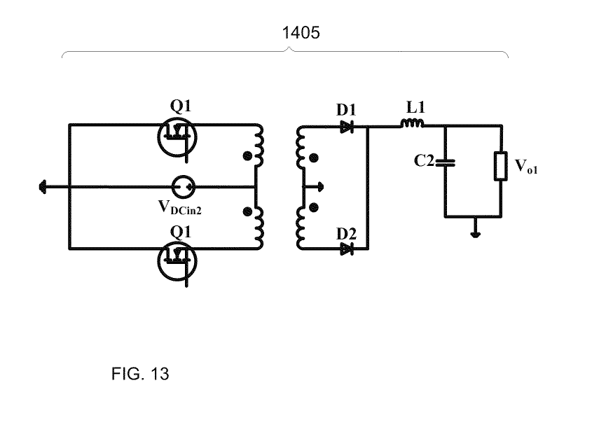

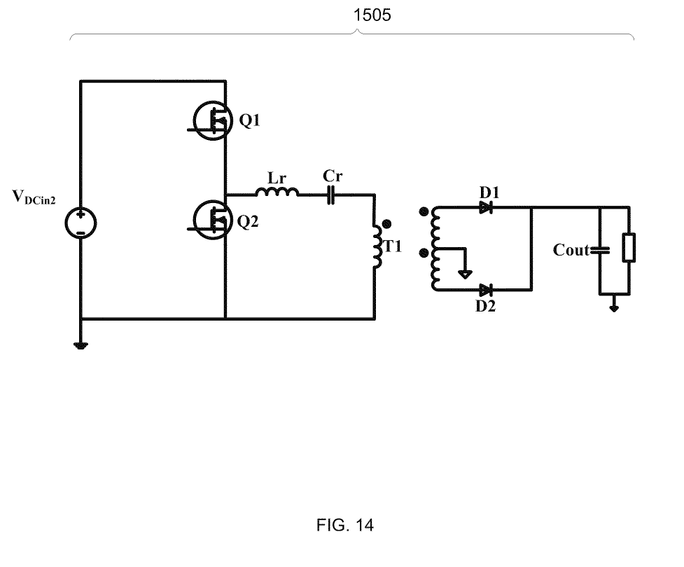

Referring to FIG. 4, a buck converter 509 can be implemented for converter 9 in the first stage 3 implemented as converter 503 and followed by flyback converter 305 as second stage 5. Similarly, the second stage can also be a forward converter 1305 (FIG. 12), half bridge converter 1205 (FIG. 11) or LLC half bridge converter 1505 (FIG. 14), full bridge converter 1105 (FIG. 10) or push-pull converter 1405 (FIG. 13). V_{DCin2} is used in FIGS. 10, 11, 12, 13, and 14 to represent input from the first stage 3, which is not shown. The general operation of such converters 1105, 1205, 1305, 1405, 1505 is well known to those skilled in the art, and the application of such converters to the implementations described herein will be well understood by those skilled in the art based on the description provided herein and the knowledge of a person skilled in the art. Similarly, those skilled in the art based on the description provided herein will understand that other isolated DC/DC converters may be used in the second stage 5.

The number of outputs can be designed to any number according to design requirements.

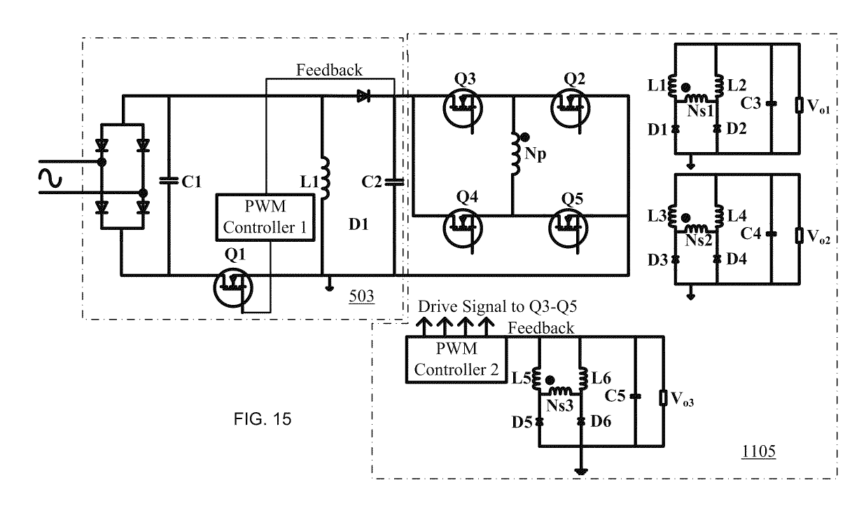

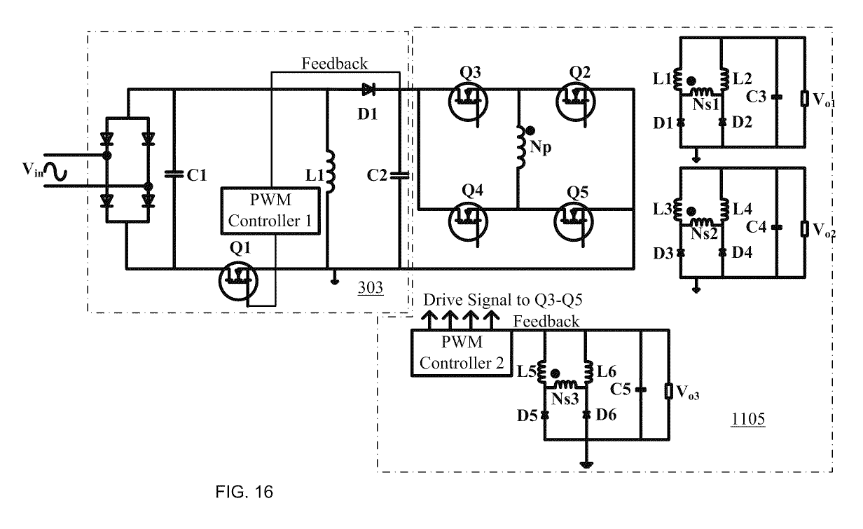

For illustration, FIG. 15 provides an example buck first stage 503 and full bridge second stage 1105 and FIG. 16 provides an example buck boost first stage 303 and full bridge second stage 1105.

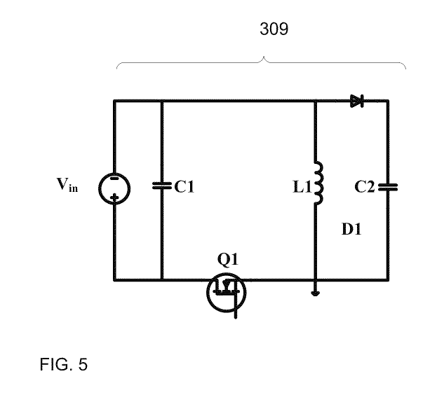

Referring to FIG. 5, the modified buck-boost converter 309 is separately shown, with Vin representing rectified voltage V_{RecDC}. The operation of the modified buck-boost converter 309 is similar to a conventional buck-boost 409. The operation states will be discussed as following. An advantage of the modified buck-boost can be that the MOSFET Q1 in the converter can be driven by using a low side MOSFET driver, not shown, which can reduce cost.

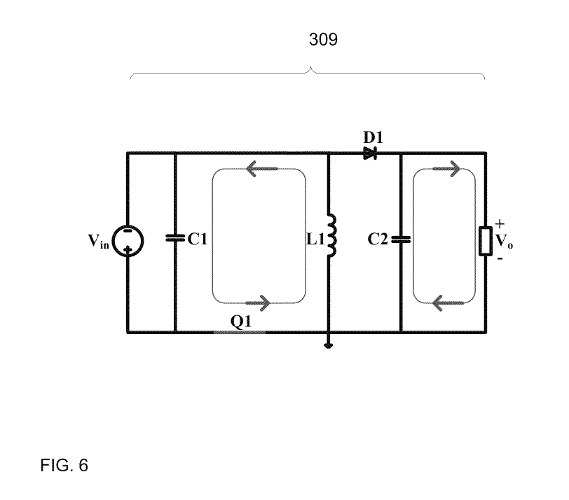

A first state is shown in FIG. 6, Q1 turns-on at t0, the inductor current begins to increase. There is no current goes through diode D1. Output capacitor C2 provides energy to the load during this period.

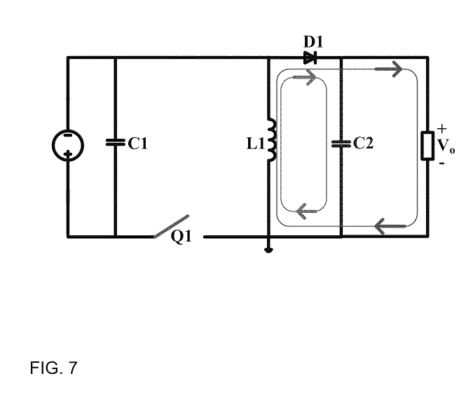

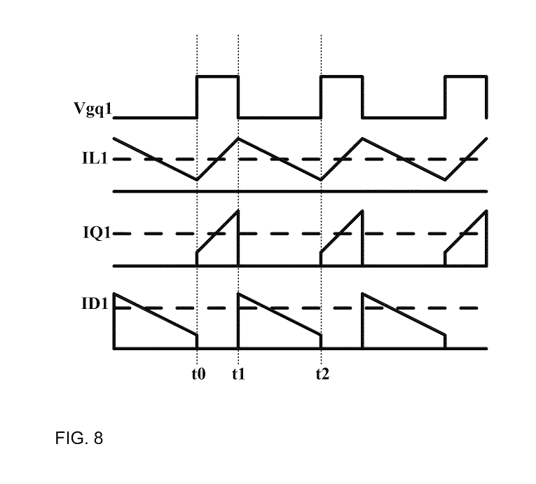

A second state is shown in FIG. 7. Q1 turns off at t1, and inductor L1 begins to transfer energy to the load and output capacitor, and inductor L1 current begins to decrease. One period ends at t2. From t0 to t2 is one period. The operation of the converter 309 repeats from one period to the next. The current waveform in inductor L1 and MOSFET Q1, Diode D1 are shown in FIG. 8.

Assuming as an example that the buck-boost converter 309 operates in continuous mode, the following equations can be used to design an example implementation of the buck-boost 309.

$${V}_{o} = \frac{{V}_{in} D}{1 - D} \qquad ( 1 )$$

Equation (1) is derived using output inductor volt-seconds in the steady-state, D is duty cycle. (D=Ton/Ts).

V_{Q1}=V_{D1}=Vᵢₙ+Vₒ (2)

Equation (2) is voltage stress across MOSFET Q1 and D1, the max voltage stress equals input voltage plus the output voltage.

$$Δ {I}_{L} = \frac{{V}_{o}}{L} ( 1 - D ) Ts \qquad ( 3 )$$

Equation (3) can be used to calculate the current ripple through the inductor. Equation (4) can be used to calculate the average input current. Equation (5) can be used to calculate the average inductor current.

$$\begin{matrix}{I}_{in\_avg} = \frac{{P}_{out}}{{V}_{in}} & ( 4 ) \\ {I}_{LAVG} = \frac{{I}_{o}}{( 1 - D )} & ( 5 )\end{matrix}$$

Equation (6) can be used to calculate the peak current through the MOSFET Q1 and D1.

I_{D1PK}=I_{Q1PK}=I_{LAVG}+ΔI_{L}/2 (6)

The above equations can be used to specify the converter 309. It will also be evident in the example implementation that the use of the converter 309 in a first stage 3 of an AC/DC two stage converter 1 can allow for a planar transformer to be used for the second stage 5.

The following design constraints may be assumed as an example for a first stage 303 including a buck-boost converter 309: Input Voltage AC: 85V-265V, Output Voltage 30V, Output Power 20 W.

If the AC range is from 85V-265V after the bridge rectifier 307 the DC voltage V_{RecDC} will be Vdc=\sqrt{2} VAC, then the DC will be 120VDC-374VDC. So the first stage 303 will need be designed to use the maximum voltage stress which is 374VDC.

Equation (1) will be used to calculate duty cycle. Vin=374V, Vo=30V, D=0.075

Equation (2) and (6) will be used to calculate the voltage rating and current rating of MOSFET, Diode, and Inductor. After the ratings are known, the appropriate components can be selected.

Using (2) the maximum voltage stress of MOSFET and diode is Vin+Vo=367V+30V=397V, so a 500V MOSFET and diode can be used in the circuit, to provide some safety margin.

The current rating of the MOSFET and diode is related to the inductor value. A large inductor will reduce current ripple but the size of the inductor will also be large. Also, the inductor value needs to be large enough to keep the peak current from becoming too large. In this example, a 470 uH inductor can balance the above factors, and the max current stress of the inductor, MOSFET, and diode is about 1.09 A.

Thus, for the power components: MOSFET and iode are 500V/1.09 A, inductor is be 470 uH/1.09 A.

Assuming a flyback second stage 305 the voltage stress seen by Q2 for the flyback transformer N is 30V, and at that voltage stress a MOSFET Q1 can typically operate at 700 KHz which balance the core size and switching loss. High switching frequency can allow for a reduction in the core size, but can also result in high switching loss. At different bus voltage for example 50V, or 20V different switching frequency can be selected. The actual value may vary from manufacturer to manufacturer and model to model. Based on the example discussed above, for a typical RM7 core planar transformer operating at 700 KHz and 30V the primary turns required can be as low as twelve. Again, the actual number may vary based on the materials used and from manufacturer to manufacturer. As twelve turns is within the design capacity of an RM7 core, a standard planar transformer core, a planar transformer can be practically utilized.

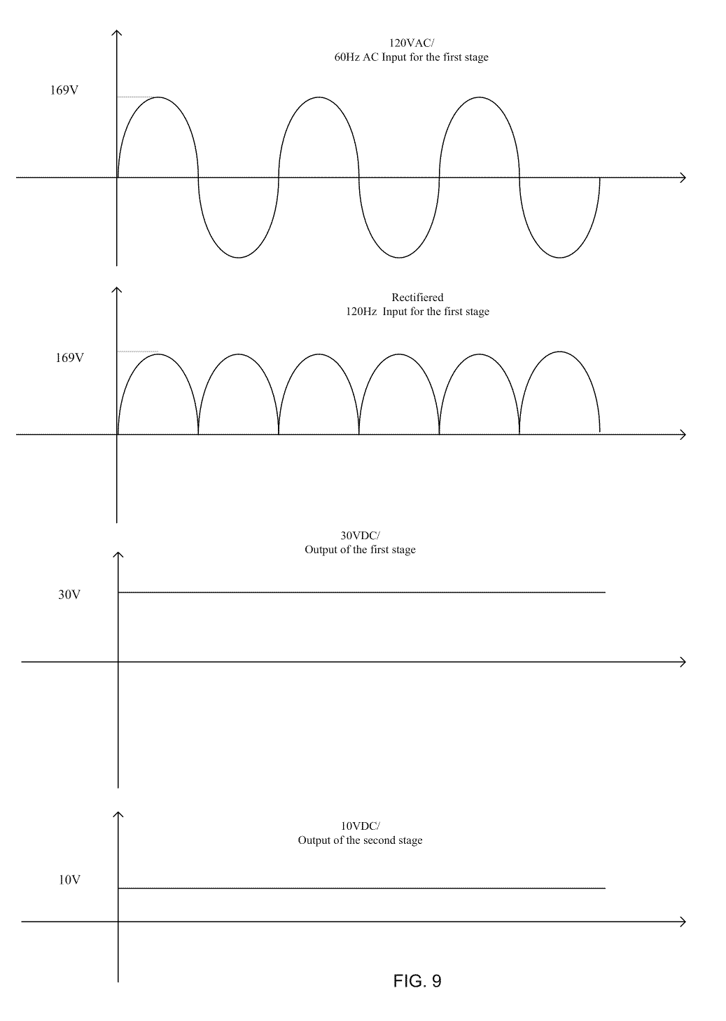

FIG. 9 provides waveform examples of the first stage 3 and second stage 5 for above design example. In 120V/60 Hz AC is input to the first stage 3, after the bridge rectifier 7 60 Hz AC is change to a 120 Hz DC voltage. PWM controller of the first stage 3 controls the switch Q1 to regulate this 120 Hz DC to a low ripple 30VDC this is the output V_{RegDC} of the first stage 3. The second stage 5 will regulate this 30VDC to 10VDC Output1. The design parameters can be changed according to design requirements.

Thus, an AC/DC converter 1 generates an intermediate bus voltage that is lower than the peak voltage of the AC input voltage. A two stage topology has been described. The output of a non-isolated AC-DC converter is used as bus voltage for the second stage to reduce the peak input AC voltage to the second stage. In some example implementations the second stage can operate at a high switching frequency to increase power density, and cross regulation can be used to control the output of multiple outputs with the help of a planar transformer. Power density and reliability can be improved in some example implementations.

An AC/DC converter 1 can, for example, be utilized as an auxiliary power supply within a universal switching power supply as an auxiliary power supply to power integrated circuits and control circuits in the primary and secondary side of the universal power supply. Current auxiliary power supplies often utilize a single stage flyback converter with an optocoupler. As mentioned previously the AC/DC converter 1 can have benefits over a single stage flyback converter with optocoupler. As will be evident to those skilled in the art the AC/DC converter 1 can be utilized in other applications.

Example PWM controllers that may be used as the controllers described herein and shown in the FIGS. can be: National Semiconductor LM5020 datasheets for which can be found at www.national.com; Semiconductor Components Industries, LLC NCP1200, NCP1379, or NCP1380EVB/D datasheets for which can be found at http://onsemi.com; or Texas Instruments UCC28C40-45 or UCC38C40-45 datasheets for which can be found at www.ti.com. Example PFC controllers that may be used for the first stage controllers described herein and shown in the FIGS. can be: Fairchild Semiconductor Corporation FAN7530 or FAN400A datasheets for which can be found at www.fairchildsemi.com; Texas Instruments UCC28050-1 or UCC38050-1 datasheets for which can be found at www.ti.com; or STMicroelectronics L6562A datasheets for which can be found at www.st.com. As will be evident to those skilled in the art based upon the description herein, many other integrated circuit PWM or PFC controllers can be used in implementations of the converters described herein.

Other aspects and embodiments of those aspects, and further details of the above aspects and embodiments, will be evident from the detailed description herein.

Application of one or more of the above-described techniques may provide one or more advantages. For example, some embodiments of the example two stage AC/DC converters described herein when, for example, compared to a conventional flyback topology often used in AC/DC switching power supplies can reduce voltage stress across one or more switches in the converters. This can result in longer life for the switches. Also, the switch frequency can be higher. As the switch frequency can be higher, the power density can increase. Also, an isolation transformer with fewer windings and a reduced size can be used. Use of a planar transformer becomes practical at higher switching frequencies. A planar transformer can provide more accurate regulation of output voltage. The output voltage cross-regulation between multiple output voltages can be accurately achieved when using a planar transformer. In addition, increased accuracy in regulation of output voltages can allow the use of a feedback signal from a voltage output of a secondary winding of the planar transformer to provide isolated feedback for control of switch control circuitry. Such planar transformer-based isolated feedback can reduce cost and increase reliability, for example, when compared to optocoupler-based isolated feedback typically used in conventional flyback topologies for AC/DC isolated switching power supplies.

It will be appreciated that the particular options, outcomes, shown in the FIGS. and described above are for illustrative purposes only and many other variations can be used according to the principles described.

Although the above has been described with reference to certain specific embodiments, various modifications thereof will be apparent to those skilled in the art as outlined in the appended claims.

What is claimed is:

1. An AC/DC two stage converter comprising:
a non-isolated switch-mode regulated AC/DC voltage step-down first stage converter comprising an AC input and a first DC output, wherein an AC voltage applied to the AC input is rectified and switch-mode regulated to a first DC voltage at the first DC output, and the first DC voltage is lower than a peak voltage of the AC voltage applied to the AC input, and
an isolated switch-mode regulated DC/DC second stage converter comprising a second DC input coupled to the first DC output and at least one second DC output, wherein the first DC voltage is switch-mode regulated to a second DC voltage at a second DC output.

2. The AC/DC two stage converter of claim 1 wherein the first stage converter comprises a rectifier and a non-isolated switch-mode regulated DC/DC voltage step-down converter, wherein the rectifier is operatively connected to the AC input and the non-isolated switch-mode regulated DC/DC voltage step-down converter is operatively connected between the rectifier and the first DC output, wherein the rectifier rectifies the AC voltage to a rectified voltage and the non-isolated switch-mode regulated DC/DC voltage step-down converter regulates and steps-down the rectified voltage to the first DC voltage, which first DC voltage is lower than a peak voltage of the rectified voltage.

3. The AC/DC two stage converter of claim 2 wherein the non-isolated switch-mode regulated DC/DC voltage step-down converter is a buck converter.

4. The AC/DC two stage converter of claim 2 wherein the non-isolated switch-mode regulated DC/DC voltage step-down converter is a buck boost converter.

5. The AC/DC two stage converter of claim 1 wherein the second stage converter is a flyback converter.

6. The AC/DC two stage converter of claim 1 wherein the second stage converter is a full bridge converter.

7. The AC/DC two stage converter of claim 1 wherein the second stage converter is a half bridge converter.

8. The AC/DC two stage converter of claim 1 wherein the second stage converter is a push-pull converter.

9. The AC/DC two stage converter of claim 1 wherein the second stage converter is a half bridge LLC converter.

10. The AC/DC two stage converter of claim 1 wherein the second stage converter is forward converter.

11. The AC/DC two stage converter of claim 1 wherein the second stage converter further comprises a planar isolation transformer.

12. The AC/DC two stage converter of any one of claims 1 wherein the second converter further comprises a planar isolation transformer and the first DC voltage is in a range to properly operate the planar transformer and to allow the second switch to operate at sufficiently high frequency for proper operation of the planar transformer.

13. The AC/DC two stage converter of claim 1, wherein the second converter comprises a plurality of second DC outputs, wherein the plurality of second DC outputs comprises the second DC output, and each second DC output of the plurality of second DC outputs is isolated from the other second DC outputs.

14. The AC/DC two stage converter of claim 13, wherein the respective second DC voltages are different from one another.

15. The AC/DC two stage converter of claim 13 where the second stage converter further comprises a planar isolation transformer, and the isolation transformer has a primary winding associated with the second DC input and a plurality of secondary windings, each secondary winding associated with a respective second DC output.

16. The AC/DC two stage converter of claim 1 wherein the second stage converter further comprises a second MOSFET switch and a second controller is operatively connected to the second MOSFET switch and non-isolated operatively connected to a second voltage output such that the second controller causes the second MOSFET switch to switch-mode regulate the second stage converter based on a second DC output voltage signal.

17. The AC/DC two stage converter of claim 1, wherein the first stage converter further comprises a first MOSFET switch and a first controller operatively connected to the first MOSFET switch and the first DC output such that the first controller causes the first MOSFET switch to switch-mode regulate the first stage converter based on the first DC output voltage.

18. The AC/DC two stage converter of claim 1, wherein stage 1 and stage 2 are controlled using a single controller.

19. A method of operating an AC/DC two stage converter comprising:
in a non-isolated first stage, rectifying an AC voltage at an AC input of the converter to a rectified voltage, and switch-mode regulating the rectified voltage to a first DC voltage lower than a peak AC voltage of the AC input to the converter, wherein the rectified voltage and the first DC voltage share a common voltage ground, and
in an isolated second stage, switch-mode regulating the first DC voltage to a DC voltage at a second DC output of the converter, while isolating the DC output from the AC input.
